(19) United States
(12) Patent Application Publication
(10) Pub. No.: US 2025/0139878 A1
(43) Pub. Date: May 1, 2025

(54) COMPRESSED REPRESENTATION FOR DIGITAL ASSETS

(71) Applicant: Adobe Inc., San Jose, CA (US)

(72) Inventors: Krishna Bhargava Mullia Lakshminarayana, San Francisco, CA (US); Xin Sun, Palo Alto, CA (US); Miloš Hašan, Lafayette, CA (US); Fujun Luan, Menlo Park, CA (US)

(73) Assignee: Adobe Inc., San Jose, CA (US)

(21) Appl. No.: 18/499,593

(22) Filed: Nov. 1, 2023

(51) Int. Cl. G06T 15/50; G06T 15/06; G06T 15/20

(52) U.S. Cl. CPC G06T 15/506; G06T 15/06; G06T 15/20

(57) ABSTRACT

Techniques for generation of compressed representations for digital assets are described that support computationally efficient and high fidelity rendering of digital assets with a variety of geometries under arbitrary lighting conditions and view directions. A processing device, for instance, receives a digital asset defined by a three-dimensional geometry to be included in a digital scene. The processing device generates a compressed representation of the digital asset that maintains a geometry of the digital asset and includes a precomputed light transport. The processing device then deploys the compressed representation into the digital scene, such as at a location relative to one or more digital scene elements. The content processing system renders the digital asset by applying one or more lighting effects to the compressed representation based on the precomputed light transport and the location relative to the one or more digital scene elements.

### BACKGROUND

Computer graphics techniques model digital objects in a variety of ways to generate realistic representations of the digital objects in a digital environment. For example, a three-dimensional digital scene includes several digital objects and light sources that are viewable from various perspectives. To simulate the behavior of light in the digital scene, conventional approaches employ path tracing techniques and algorithms to trace individual light rays as they interact with objects and surfaces in the digital scene. However, such interactions are exceedingly complex, and conventional path tracing techniques struggle to efficiently generate high fidelity representations of digital objects with complex geometries. Accordingly, conventional techniques to render digital objects are computationally expensive and are often not suitable for real-time applications such as interactive games or virtual reality.

### SUMMARY

Techniques for generation of compressed representations for digital assets are described that precompute a light transport for a digital asset to support lighting effects with reduced consumption of computational resources. In an example, a processing device receives a digital asset defined by a three-dimensional geometry to be included in a digital scene. The processing device generates a compressed representation of the digital asset that maintains a geometry of the digital asset and includes a precomputed light transport that represents how light interacts with and/or propagates through the digital asset. The compressed representation, for instance, is a neural model of the digital asset that includes a feature grid such as a triplane representation and a multilayer perceptron (MLP) that are configured to support shading operations, e.g., relighting under a variety of lighting conditions and view directions with reduced computational overhead.

Accordingly, the processing device deploys the compressed representation into the digital scene in a location relative to one or more digital scene elements such as digital light sources and/or other digital assets. The processing device then applies one or more lighting effects to the compressed representation, such as to relight the compressed representation, based on the precomputed light transport and on the location relative to the one or more digital scene elements. In this way, the techniques described herein conserve computational resources while performing high fidelity shading operations.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ the compressed representations for digital assets techniques described herein.

FIG. 2 depicts a system in an example implementation showing operation of a compression module in greater detail.

FIG. 3 depicts an example of a triplane representation generated based on a digital asset.

FIG. 4 depicts an example to generate a shading value to apply to a shading point of the digital asset in accordance with the techniques described herein.

FIG. 5 depicts an example of an example of property vectors for a surface based digital asset and a fiber-based digital asset.

FIG. 6 depicts an example of generation of relit digital assets based on a compressed representation with a changed condition of a digital light source.

FIG. 7 depicts an example of generation of relit digital assets based on a compressed representation under different lighting conditions.

FIG. 8 depicts an example of rendering a variety of digital assets based on compressed representations with various lighting conditions and view directions.

FIG. 9 depicts an example of rendering multiple digital assets based on compressed representations within a digital scene.

FIG. 10 is a flow diagram depicting an algorithm as a step-by-step procedure in an example implementation that is performable by a processing device to generate a compressed representation based on a digital asset to be inserted into a digital scene.

FIG. 11 illustrates an example system including various components of an example device that can be implemented as any type of computing device as described and/or utilized with reference to FIGS. 1-10 to implement embodiments of the techniques described herein.

### DETAILED DESCRIPTION

### Overview

Path tracing is a rendering technique used in computer graphics that attempts to simulate behavior of light in a digital scene. For instance, conventional path tracing techniques trace rays from a virtual camera into a digital scene and accumulate information about an amount of light that the rays encounter as they propagate throughout the digital scene. For instance, as the rays propagate, they interact with digital objects that have a variety of surface properties and are reflected, refracted, absorbed, transmitted, scattered, emitted, etc. Path tracing techniques model these interactions of the rays with the various surfaces and materials within the scene and estimate the overall lighting and illumination of the scene. Conventional path tracing techniques often employ Monte Carlo methods that randomly sample a number of paths of light rays per pixel to estimate the contribution of each ray to a final pixel color.

However, due to the number of interactions, the length of the rays, the complexity of path tracing algorithms, and the number of samples that Monte Carlo methods rely on, conventional path tracing techniques are computationally expensive. Thus, implementation of such techniques are limited to specialized processing devices with sufficient processing power. Further, due to the high rendering time, conventional path tracing approaches are often not suitable for real-time applications such as interactive games or virtual reality/augmented reality, particularly with digital scenes that include digital objects with complex geometries.

Several approaches have been proposed to reduce the computational overhead of path tracing techniques, such as by reducing a number of light interactions and/or leveraging a simplified shading model. However, these techniques sacrifice visual quality, which results in unrealistic and/or low-quality renderings. Other conventional approaches support novel view synthesis and “bake” scene lighting into a digital object, however such objects cannot be relit, e.g., respond to a new lighting condition such as illumination of a new scene, which limits utility of such approaches.

Accordingly, techniques and systems to generate compressed representations for digital assets are described. A compressed representation, for instance, represents a geometry of a digital asset and includes a precomputed light transport. Thus, the compressed representation is inserted into a digital scene and is able to be relit to display a realistic visual appearance under a variety of lighting conditions, view angles, and/or interactions with additional scene elements with reduced consumption of computational resources.

Consider an example in which a user designs a digital scene that includes several digital objects and one or more light sources. The user desires to add a digital asset to the digital scene that represents a geode, e.g., a hollow spherical rock with a crystalline interior. The geode has varied material properties as well as a complex geometry, with an intricate structure of various crystals that includes a large number of faceted surfaces.

A conventional approach to render the digital asset includes simulating interactions of hundreds of thousands of rays with the various portions of the digital asset. The rays have a plurality of interactions as they propagate throughout the digital scene (e.g., the rays are scattered, reflected, refracted, absorbed, transmitted, refracted, etc.) and conventional approaches calculate a complex light transport for each interaction. Thus, conventional techniques are computationally expensive and not practical for a variety of rendering scenarios. For instance, conventional path tracing techniques are not practical to implement by a variety of devices (e.g., mobile devices, tablets, laptops, etc.) and are not suitable for real-time applications.

To overcome these limitations, a processing device implements a content processing system to generate compressed representations for digital assets, which support shading operations such as “relighting,” which includes editing a visual appearance of digital assets under a variety of light and view conditions. Whereas conventional techniques involve computation of complex scattering interactions, the techniques described herein support end-to-end shading operations at a first intersection of a ray with a digital asset. To do so, the content processing system receives a digital asset to be included in a digital scene. Generally, the digital asset is defined by a three-dimensional geometry of a digital object. In this example the digital asset models a geometry of the geode, such as by using a triangular mesh.

The content processing system generates a compressed representation of the digital asset that includes a precomputed light transport based on the three-dimensional geometry. Generally, light transport represents how light interacts with and/or propagates through the geometry of the digital asset. For instance, the light transport models interactions (e.g., reflection, refraction, scattering, absorption, transmission, emission, etc.) of light with the various facets and the geode and further considers material properties of the geode. However, iterative computation of the complex light transport during rendering, such as each time the digital scene changes, is computationally expensive which limits utility. To conserve computational resources during rendering, the content processing system precomputes the light transport and the compressed representation encodes the precomputed light transport into a neural model that includes a feature grid such as a triplane representation as well as a multilayer perceptron (MLP) decoder.

The triplane representation, for instance, includes feature maps that correspond to dimensions of the three-dimensional geometry to represent the digital asset. In an example, the content processing system generates and subsequently orthogonally projects the feature maps to construct the triplane representation. For instance, the content processing system generates an X-Z feature map that corresponds to an XZ plane of the digital asset, an X-Y feature map that corresponds to an XY plane of the digital asset, and a Y-Z feature map that corresponds to a YZ plane of the digital asset to map dimensions of the geometry to the feature grid. In this way, the triplane representation is able to represent a variety of different geometries and structures. The MLP of the compressed representation is configured to receive an input vector extracted from the triplane representation to generate a radiance value, e.g., an RGB color value, to apply to one or more pixels of the digital asset as further described below.

To generate the compressed representation, the content processing system jointly trains the triplane representation and the MLP. To do so, the content processing system generates a training dataset that is based on the digital asset. The training dataset includes training images that depict the digital asset from a variety of virtual camera locations (e.g., view angles and/or view directions) and under various lighting conditions. Further, the training dataset includes training data at a pixel level, e.g., training samples for each visible pixel within the training images.

The training samples, for instance, are tuples that define an intersection point at which a primary ray traced from a virtual camera intersects with the geometry of the digital asset (i.e., a shading position), a view direction, a light direction to a light source in the digital scene, and a radiance value (e.g., an RGB value) that is usable as a ground truth. In some examples, the training samples further include a visibility term that represents self-occlusion properties of the digital asset, e.g., self-shadowing. Additionally or alternatively, the training samples include one or more terms that define surface properties for the digital asset, such as a surface normal for surface-based assets and/or a fiber direction and cross-section offset for digital assets that include one or more fibers.

Continuing with the above example, the content processing system generates a plurality of training images (e.g., four hundred) of the geode with variable view directions and/or lighting conditions. For each pixel of the training images, the content processing system generates a training sample that includes a radiance value to be used as a ground truth, a shading position, a view direction, a light direction, and a visibility term that indicates whether each pixel is self-occluded by the digital asset, e.g., whether the shading position is shadowed by another portion of the digital asset. Because the geode is a surface-based asset, the content processing system further generates surface normals, e.g., a normal vector at the shading position, for the training samples.

Using the training dataset, the content processing system trains the triplane representation and the MLP of the compressed representation. For instance, the content processing system leverages the compressed representation to predict an outgoing radiance based on a training sample and compares the predicted radiance with the ground truth radiance to update various parameters and weights of the triplane representation and the MLP. This process is iterated for each of the training samples in the training dataset to construct the compressed representation. In various examples, the training process is repeated a plurality of times across the training dataset, e.g., 100-500 times, with an order of the training samples randomly selected for each repetition.

Once generated, the content processing system is operable to deploy the compressed representation into the digital scene. The digital scene includes one or more digital scene elements, such as one or more digital light sources and/or additional digital assets. The content processing system renders the digital asset within the digital scene by applying one or more lighting effects to the three-dimensional geometry based on the precomputed light transport and the location relative to the one or more digital scene elements. For instance, the lighting effect includes a shading operation to “relight” the compressed representation, such that the digital asset is rendered to display a realistic appearance under lighting conditions of the scene.

Continuing with the above example, the content processing system inserts the compressed representation of the geode into the digital scene and renders the geode based on digital scene elements included in the digital scene and the precomputed light transport. The techniques described herein are integrable with a variety of rendering techniques, thus the content processing system is operable to leverage a path tracer and/or a rasterizer-based renderer to relight the compressed representation. For example, the content processing system utilizes a path tracer to determine an intersection point (e.g., a shading point) of a primary ray traced from a virtual camera with the three-dimensional geometry. The content processing system then queries the triplane representation to extract a feature vector that corresponds to the intersection point. The feature vector, for instance, includes a sum of features that are bilinearly interpolated from the orthogonally projected planes of the triplane representation.

The content processing system further generates a property vector that includes information particular to the intersection point such as a view direction and a light direction to one or more light sources in the digital scene. For surface-based digital assets, the property vector includes a surface normal and for fiber-based digital assets the property vector includes a fiber direction and cross-section offset. In some examples, the property vector further includes a visibility term that represents self-occlusion properties of the digital asset. Inclusion of the visibility term improves self-shadowing of the compressed representation which in turn increases the visual quality of the rendered digital asset.

To calculate the visibility term, the content processing system is configured to trace a ray, e.g., an occlusion ray, from the intersection point along the light direction, e.g., in a direction to a digital light source within the digital scene. The content processing system generates the visibility term as a binarized value based on whether the occlusion ray intersects the three-dimensional geometry. For instance, if the occlusion ray intersects the three-dimensional geometry, the content processing system determines the intersection point is occluded and assigns the visibility term as zero. If the occlusion ray does not interest the three-dimensional geometry, the content processing system determines the intersection point is not occluded and assigns the visibility term as one. In this way, the techniques described herein increase realism of the rendered asset by accounting for self-occlusion and subtle shadowing effects.

The content processing system then generates an input vector by concatenating the feature vector with the property vector. The trained MLP receives and evaluates the input vector to generate a shading value, e.g., an RGB value, for one or more pixels associated with the intersection point. The content processing system performs this process for each primary ray traced from the virtual camera that intersects the compressed representation to determine shading values for each visible pixel. The content processing system then applies the shading values to the pixels to generate a photorealistic rendering of the geode with accurate color and lighting simulation.

This process is repeatable for changed conditions of the digital scene, such as a change in a position of the view direction, added or removed digital assets from the digital scene, a changed condition of the light source such as intensity, location, type, etc. Thus, the compressed representation is responsive to variation in view and lighting conditions without repeated calculation of the light transport. In this way, the techniques described herein support high fidelity shading operations while conserving computational resources relative to conventional techniques.

Further discussion of these and other examples and advantages are included in the following sections and shown using corresponding figures. In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

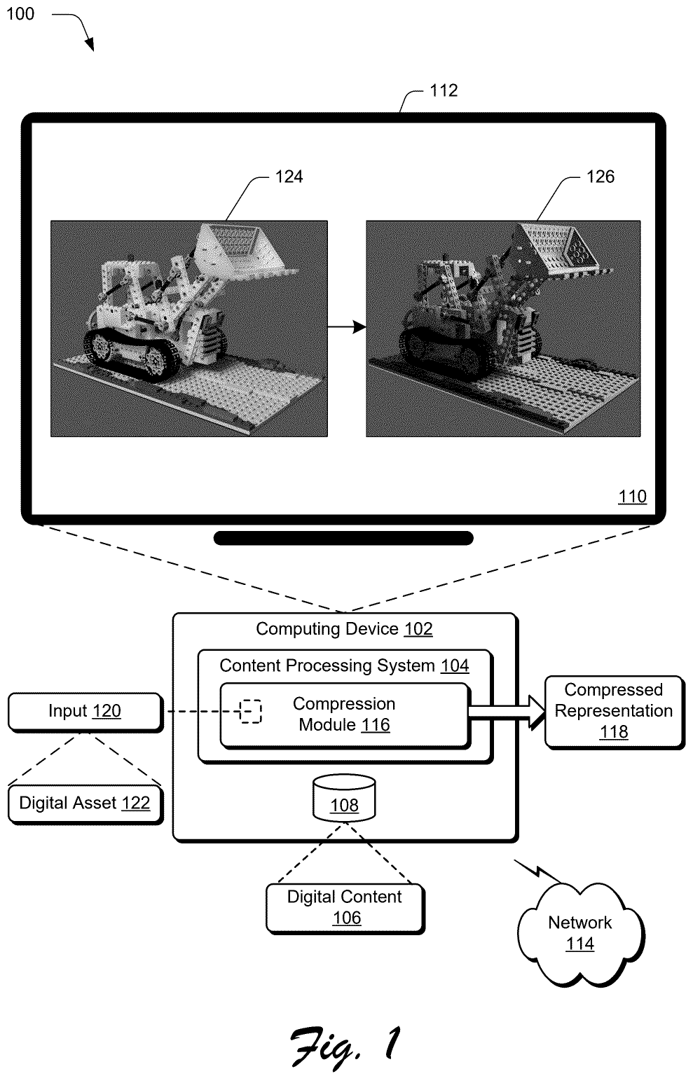

FIG. 1 is an illustration of a digital medium environment 100 in an example implementation that is operable to employ the compressed representations for digital assets techniques described herein. The illustrated environment 100 includes a computing device 102, which is configurable in a variety of ways.

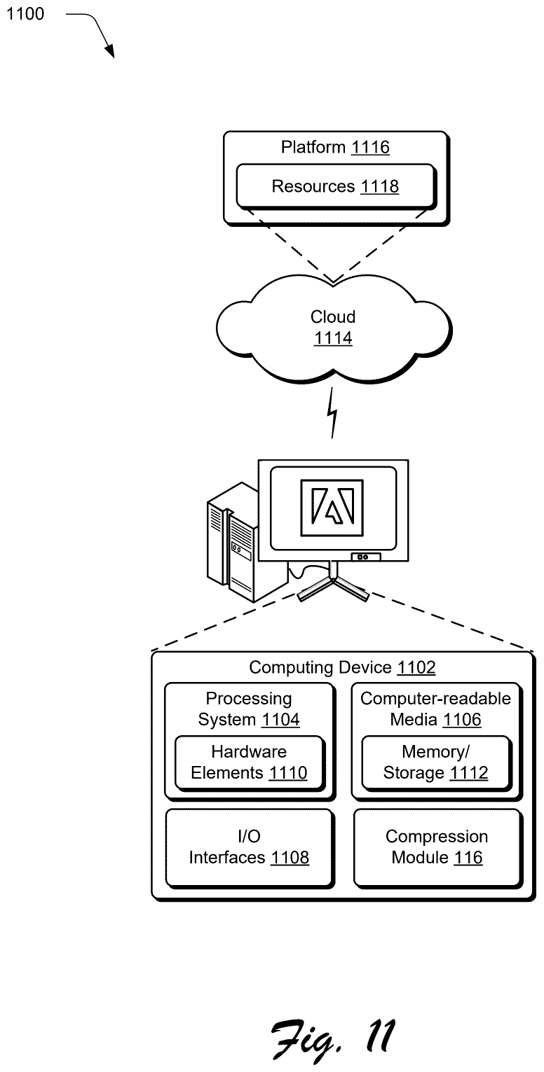

The computing device 102, for instance, is configurable as a processing device such as a desktop computer, a laptop computer, a mobile device (e.g., assuming a handheld configuration such as a tablet or mobile phone), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform operations “over the cloud” as described in FIG. 11.

The computing device 102 is illustrated as including a content processing system 104. The content processing system 104 is implemented at least partially in hardware of the computing device 102 to process and transform digital content 106, which is illustrated as maintained in storage 108 of the computing device 102. Such processing includes creation of the digital content 106, compression of the digital content 106, modification of the digital content 106, and rendering of the digital content 106 in a user interface 110 for output, e.g., by a display device 112. Although illustrated as implemented locally at the computing device 102, functionality of the content processing system 104 is also configurable in whole or in part via functionality available via the network 114, such as part of a web service or “in the cloud.”

An example of functionality incorporated by the content processing system 104 to process the digital content 106 is illustrated as a compression module 116. The compression module 116 is configured to generate a compressed representation 118 based on an input 120 that includes a digital asset 122. Generally, the digital asset 122 is defined by a three-dimensional geometry of a digital object to be included in a digital scene.

In the illustrated example, the digital asset 122 is a surface-based asset, such as a representation of an interlocking building block model of a track loader. The track loader includes a complex geometry defined by numerous cylindrical studs that protrude from individual building blocks and apertures throughout the body of the track loader. Further, the track loader is represented as a soft plastic material which causes complex scattering interactions with various light rays. Due to the complex geometry and material composition of the track loader which cause elaborate light scattering effects, conventional path tracing methods to render the digital asset 122 are computationally expensive and not suitable for a variety of implementations. Accordingly, the compression module 116 is operable to generate a compressed representation 118 of the track loader, which encodes a precomputed light transport within a neural model to support computationally efficient shading operations such as lighting and/or relighting. To do so, the compression module 116 generates and leverages a training dataset based on the digital asset 122 to configure the compressed representation 118 to be responsive to a variety of light and view conditions.

In the illustrated example, the compression module 116 inserts the compressed representation 118 into the digital scene which includes a digital light source. The compression module 116 then renders the digital asset 122 for display by the display device 112 based on precomputed light transport and the lighting conditions of the digital scene, which is displayed as a relit asset 124. Further, the illustrated example depicts a second relit asset 126 that is rendered based on a changed condition of the digital scene. In this example, the location of the digital light source has changed to be “behind” the track loader. Accordingly, the compression module 116 renders the second relit asset 126 based on the changed condition.

Because the compressed representation 118 includes the precomputed light transport, the compression module 116 renders the relit asset 124 and the second relit asset 126 with reduced consumption of computational resources relative to conventional techniques. This overcomes conventional limitations that are forced to calculate a complex light transport for each changed condition as well as limitations of conventional techniques that simplify geometry and/or material properties of digital assets at the expense of rendering quality. Further discussion of these and other advantages is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Compressed Representations for Digital Assets

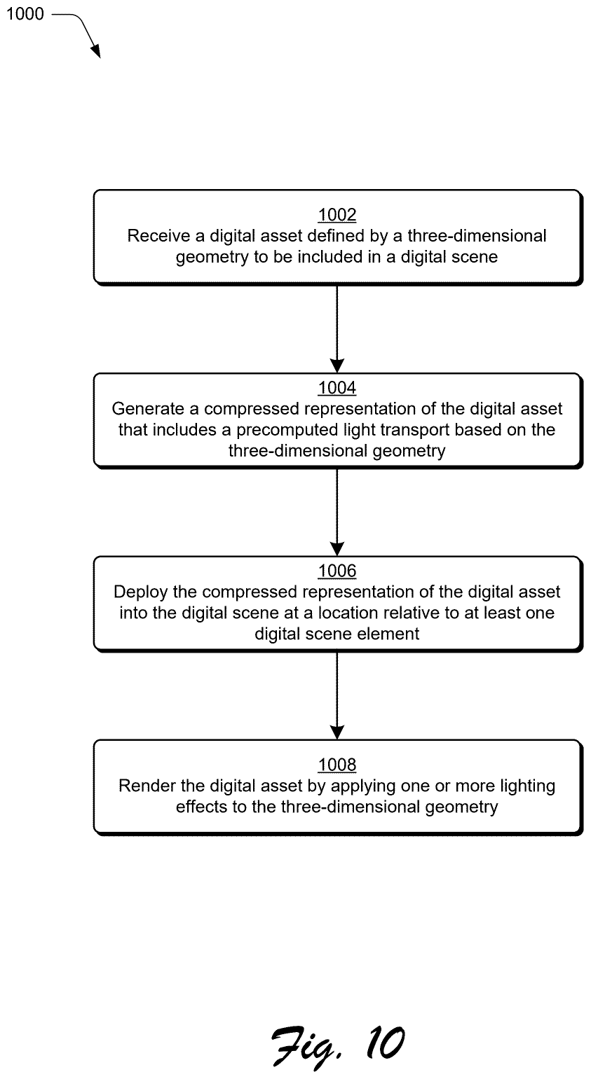

The following discussion describes techniques that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-9 in parallel with procedure 1000 of FIG. 10.

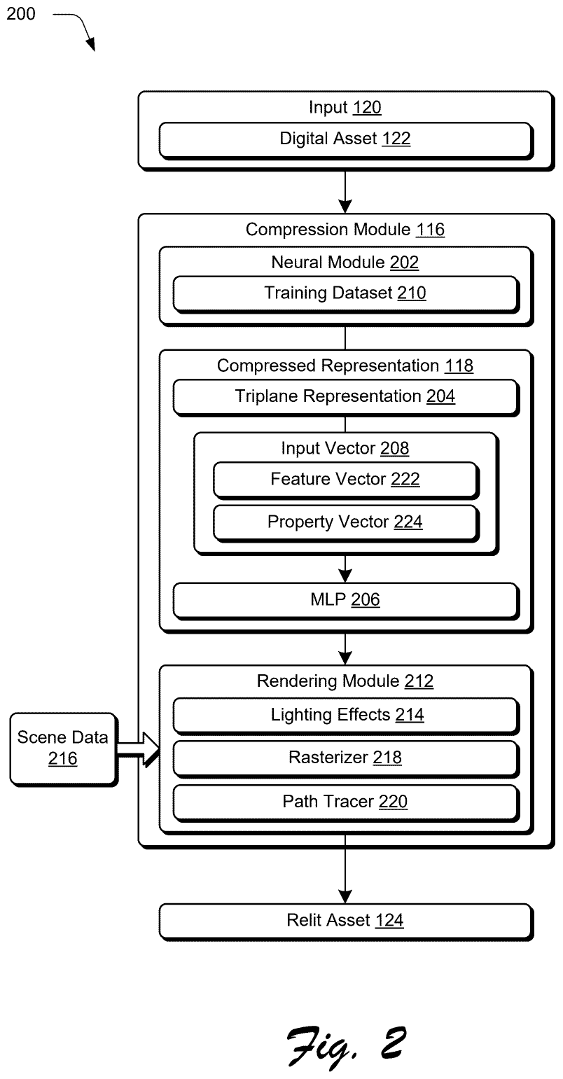

FIG. 2 depicts a system 200 in an example implementation showing operation of a compression module 116 in greater detail. Generally, the compression module 116 is operable to generate a compressed representation 118 of a digital asset 122. The digital asset 122 is definable by a variety of geometries. In various examples, the compression module 116 inserts the compressed representation 118 into a digital scene to be rendered as a relit asset 124 such as to respond to illumination of the digital scene, as further described below.

For example, the compression module 116 is operable to receive a digital asset 122 to be included in a digital scene (block 1002). The digital asset 122, for instance, is defined by a three-dimensional geometry of a digital object. The geometry is representable in a variety of ways, such as one or more procedural representations, parametric curves/surfaces, volumetric data, implicit surfaces, polygonal and/or triangular meshes, etc. As further described below, the digital scene depicts a digital environment and in various embodiments includes one or more digital scene elements such as additional digital assets, digital objects, light sources, shadows, materials/textures, virtual cameras/points-of-view, backgrounds, visual effects, particle systems (e.g., smoke/fog simulations), etc.

In various examples, the digital asset 122 is a surface-based digital asset that includes one or more surfaces. For instance, the digital asset 122 is characterized by its surface geometry, which includes information about the shape, curvature, texture, and material properties of various surfaces of the digital asset 122. Alternatively or additionally, the digital asset 122 is a fiber-based digital asset that includes one or more fiber primitives that are usable to represent individual fibers included in the digital asset 122. Generally, the individual fibers represent fine strands and/or filaments of natural materials (e.g., hair strands, blades of grass, strands of materials such as cotton, wool, silk, etc.) and/or synthetic materials, e.g., strands/filaments of polyester, nylon, acrylic, carbon fiber, etc. The digital asset 122 is further representative of a variety material properties that affect and/or cause diverse light interactions such as transparency, opacity, refractive index, reflectivity, absorption, dispersion, fluorescence, polarization, scattering properties, etc. Thus, in various examples the digital asset 122 includes a diverse range of structures, geometries and/or materials.

However, traditional techniques to render digital objects with complex geometries and/or material compositions have limited utility due to the computational expense to render such assemblies. To overcome these limitations, the compression module 116 includes a neural module 202 that is operable to generate a compressed representation 118 of the digital asset 122 (block 1004). Generally, the compressed representation 118 includes a neural model to represent a precomputed light transport based on the three-dimensional geometry of the digital asset 122. The light transport represents how light interacts with and/or propagates throughout the digital asset 122. For instance, the light transport models interactions of light rays with the digital asset 122 (e.g., reflection, refraction, scattering, absorption, transmission, emission, etc.) to determine an appearance of the digital asset 122 in a digital scene with one or more light sources.

The light transport considers a variety of factors to determine the appearance, such as features of the one or more light sources (e.g., intensity, color, position, type, movement, etc.), features of the digital asset 122 (e.g., material properties, geometry features, size, position, movement, etc.), viewing direction, interaction with other digital objects and/or participating media in the scene, shadows, occlusion, direct lighting, indirect lighting, global illumination, etc. By way of example, the light transport represents a scattering interaction of a light ray that interacts with one or more surfaces of the digital asset 122 within the digital scene.

Conventional techniques to determine an appearance of a digital object include inserting the digital object into a digital scene, and tracing individual rays within the digital scene as the rays interact with various digital objects. This includes determining effects of multiple scattering, e.g., an effect of rays bouncing off multiple surfaces. Accordingly, for digital objects with complex geometries, conventional techniques involve determining a contribution of millions of interactions to a final pixel color which is computationally inefficient and not practical in a variety of scenarios. However, by precomputing the light transport the techniques described herein support generation of a compressed representation 118 that is able to be inserted into a digital scene and respond to lighting conditions to produce high-fidelity renderings in a computationally efficient manner.

Consider, for example, that an outgoing radiance Lₒ (e.g., an RGB value) at a position xₒ with a viewing direction ωₒ (e.g., a position of a virtual camera relative to the digital asset 122) is represented as an integral of the light transport from a variety of positions and a variety of incoming lighting directions:

$${L}_{o} ( {x}_{o} , {ω}_{o} ) = {\int }_{{x}_{i} ∈ 𝒜 , {ω}_{i} ∈ ω} {L}_{i} ( {x}_{i} , {ω}_{i} ) T ( {x}_{o} , {ω}_{o} , {x}_{i} , {ω}_{i} ) {dx}_{i} d {ω}_{i}$$

where Lᵢ represents an incoming radiance at a position xᵢ with a lighting direction ωᵢ, with respective domains [symbol] and Ω. In this example, T is a transport function from {xᵢ, ωᵢ} to {xₒ, ωₒ} and is dependent on a geometry and material properties of the digital asset 122, as well as a multitude of variable length light paths. Evaluation of the light transport using conventional approaches is computationally expensive, particularly for complex geometries with various surfaces and/or one or more fibers.

Accordingly, the techniques described herein generate a compressed representation 118 that includes a precomputed light transport that can be inserted into a digital scene and accurately respond to a variety of lighting conditions with reduced computational resource consumption. For example, the neural module 202 defines an outgoing radiance Lₒ for the compressed representation 118, represented in this example as [symbol] , at a particular point x as:

$${L}_{o} ( x , {ω}_{o} ) = {\int }_{{ω}_{i} ∈ Ω} {L}_{i} ( {ω}_{i} ) 𝒯 ( x , {ω}_{o} , {ω}_{i} ) d {ω}_{i}$$

which is applicable to each point x within the fiber geometry of the digital asset 122. Thus, [symbol] (e.g., the compressed representation 118) is defined by removing a dependance on xᵢ as:

$$𝒯 ( x , {ω}_{o} , {ω}_{i} ) = {\int }_{{x}_{i} ∈ 𝒜} T ( {x}_{o} , {ω}_{0} , {x}_{i} , {ω}_{i} ) {dx}_{i}$$

In this example, [symbol] (x, ωₒ, ωᵢ) represents a radiance leaving the point x in a direction ωₒ when lit by a unit-irradiance of directional light from the lighting direction ωᵢ. In this way, the compressed representation 118 accounts for multiple scattering interactions. Thus, the compressed representation 118 precomputes the complex interactions of the light transport (e.g., shading, shadowing, scattering, etc.) such that the digital asset 122 is relightable without tracing scattering paths as in conventional approaches. For instance, a radiance (e.g., RGB color values) for a particular pixel of the digital asset 122 is determined by evaluating the compressed representation 118 based on an arbitrary view direction and lighting conditions.

In various implementations, the neural model of the compressed representation 118 includes a feature grid, such as a triplane representation 204, and a multi-layer perceptron (MLP) 206. Generally, the feature grid parameterizes a structure of the digital asset 122 such that discrete geometric locations of the digital asset 122 are indexed within a three-dimensional representation. As described in more detail below, the feature grid is queried at a particular location to generate an input vector 208 for input to the MLP 206 to generate a shading value for pixels associated with the particular location.

In some examples, the feature grid is defined by a UVT coordinate system. Additionally or alternatively, the feature grid is the triplane representation 204. In an example in which the digital asset is a fiber-based digital asset and the feature grid is defined by a UVT and/or UVW coordinate system, a U-axis and a V-axis represent a flattened structure of the digital asset 122, while the T-axis represents a “length” of one or more fiber primitives. Consider an example in which a digital asset 122 represents a wig of human hair. The U-axis and the V-axis represent a flattened “scalp” while the T-axis represents a normalized length of hairs of the wig. Thus, a (u, v, t) coordinate represents a particular voxel of the feature grid that corresponds to a point on the digital asset 122. The feature grid in this example is sampled at various coordinates to extract an input vector 208, which is usable in subsequent rendering/shading operations as further described below.

However, in various scenarios it is not practical to represent the digital asset 122 using a UVT and/or UVW coordinate system. For instance, in some examples UV coordinates are not available to represent the digital asset 122, and/or are not suitable to represent complex mesh-based assemblies, such as digital assets 122 with various surfaces. Accordingly, the neural module 202 is operable to generate the feature grid as a triplane representation 204. The triplane representation 204 includes feature maps, e.g., as aspects of the feature grid, that correspond to dimensions of the digital asset 122. The feature maps, for instance, are spatial representations that include information based on the three-dimensional geometry of the digital asset 122 as well as information learned during training as further described below. The triplane representation 204 is configurable to represent digital assets 122 with a variety of three-dimensional geometries, and thus the techniques described herein are applicable to generate compressed representations 118 for a variety of digital asset types and shapes. This overcomes limitations of conventional techniques that are limited to select types of digital assets.

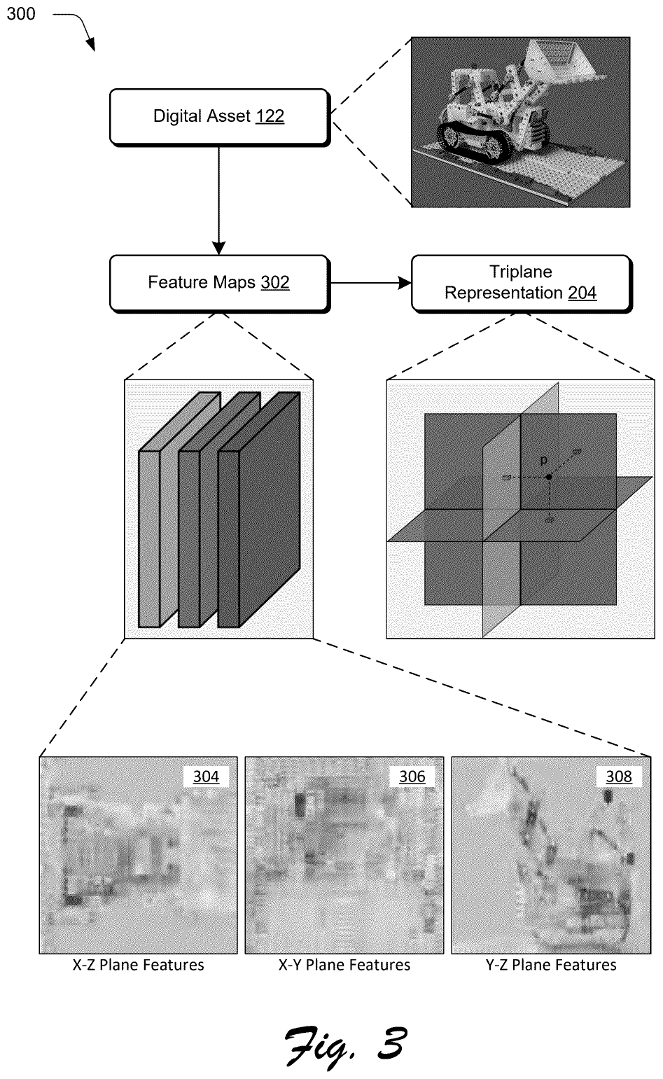

FIG. 3 depicts an example 300 of a triplane representation 204 generated based on a digital asset 122. In this example, the digital asset 122 is a representation of an interlocking building block model of a track loader. The neural module 202 is operable to generate one or more feature maps 302 to represent the digital asset 122. In this example, the neural module 202 generates an X-Z feature map 304 that corresponds to an XZ plane of the digital asset 122, an X-Y feature map 306 that corresponds to an XY plane of the digital asset 122, and a Y-Z feature map 308 that corresponds to a YZ plane of the digital asset 122.

The neural module 202 is then operable to orthogonally project the feature maps 304, 306, and 308 to construct the triplane representation 204. In this example, the feature maps 304, 306, and 308 of the triplane representation 204 include eight feature channels and have a resolution of 512×512. In one or more implementations, the triplane representation 204 is a triplane representation such as described by Chan, et al. Efficient Geometry-aware 3D Generative Adversarial Networks. In arXiv. (2021). In this way, the triplane representation 204 is able to represent a variety of digital assets 122 with various shapes, sizes, and material properties.

Generally, the MLP 206 is a multi-layer perceptron that decodes and/or encodes the precomputed light transport. For instance, the MLP 206 is trained to receive the input vector 208 queried from the triplane representation 204 along with additional information particular to the digital asset 122 and/or the digital scene, and generate a radiance value, e.g., an RGB value, based on the precomputed light transport. While in this example the decoder is a multilayer perceptron, a variety of suitable artificial neural networks are considered.

In an example, the neural module 202 generates the compressed representation 118 by jointly training the triplane representation 204 and the MLP 206 using a training dataset 210. For instance, the triplane representation 204 and the MLP 206 are trained to generate an outgoing radiance and/or a shading value, e.g., an RGB color value, for pixels of the digital asset 122 based on a known view direction and light source. The training dataset 210 is based on training images depicting the digital asset 122 viewed from a plurality of different locations within the three-dimensional digital scene with a plurality of light source locations.

The training dataset 210 further includes training samples at a pixel level, e.g., one or more training samples for each pixel that depicts the digital asset 122 within the training images. The training samples, for instance, are tuples that define an intersection point at which a primary ray traced from a virtual camera intersects with the geometry of the digital asset 122 (i.e., a shading position), a view direction, a light direction to a light source in the digital scene, and a radiance value (e.g., an RGB value) that is usable as a ground truth. In some examples, the training samples further include a visibility term that represents self-occlusion properties of the digital asset 122, e.g., self-shadowing. Additionally or alternatively, the training samples include one or more terms that define surface properties for the digital asset 122, such as a surface normal for surface-based assets and/or a fiber direction and cross-section offset for digital assets 122 that include one or more fibers.

As part of generating the training dataset 210, in one example the neural module 202 models surfaces of the digital asset 122 using one or more meshes. In an alternative or additional example, a digital asset 122 includes one or more fiber primitives and the neural module 202 models the fiber primitives as curved cylinders attached to a scalp mesh and defines material properties for the fiber primitives based on a BSDF fiber shading model such as described by Chiang, et al. A Practical and Controllable Hair and Fur Model for Production Path Tracing. Computer Graphics Forum (2016).

The neural module 202 generates the training dataset 210 based on the digital asset 122. For instance, the neural module 202 generates a plurality of training images by inserting the digital asset 122 into a training scene with varying view directions and lighting conditions. The neural module 202 then generates one or more training samples for each pixel of the training images. In one example, the neural module 202 generates four hundred training images with a resolution of 1024×1024 pixels and generates a training sample for each pixel. In various embodiments, the neural module 202 generates a plurality of rendered samples (e.g., between 128 and 1024) for each pixel, and aggregates the rendered samples to generate a training sample for each pixel. In some examples, the neural module 202 identifies pixels with respective training images that depict the digital asset 122 and generates training samples for the identified pixels.

To generate the training samples, the neural module 202 leverages a path tracer to determine an outgoing radiance, e.g. an RGB value, for visible pixels within a particular training image. In various examples, the neural module 202 is operable to disable pixel footprint integration of the path tracer such that primary rays are traced through a center of respective pixels. In this way, the outgoing radiance is determined for individual points of the geometry, rather than as an average of multiple points. Further, in some examples the neural module 202 is operable to render each pixel with a plurality of lighting directions to enhance the size and diversity of the training dataset 210.

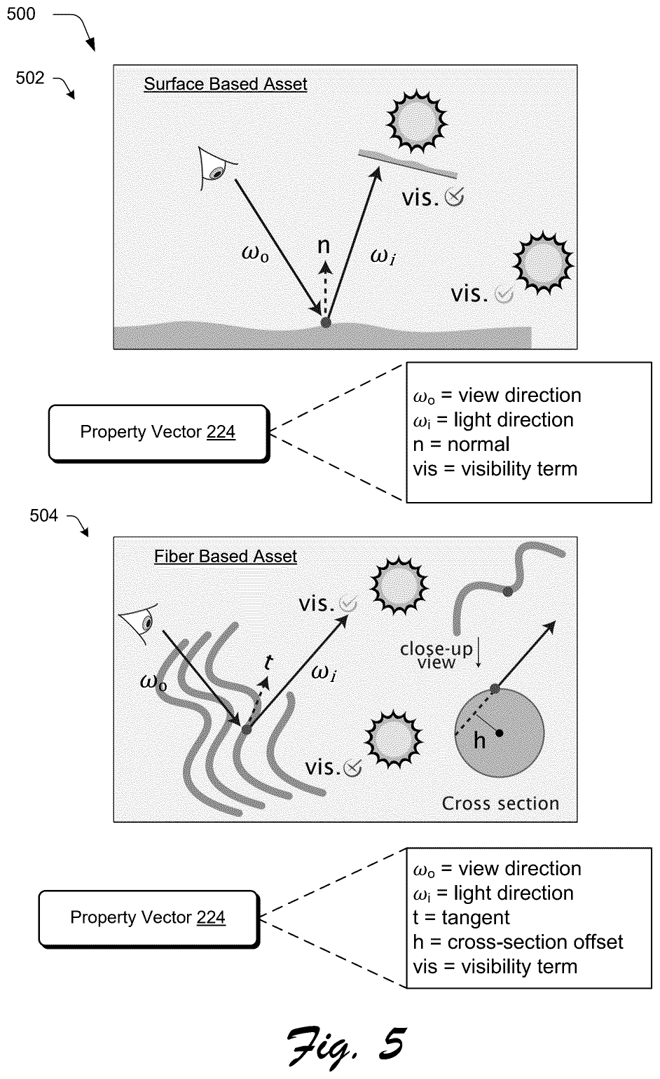

In various examples, the neural module 202 is further configured to output one or more arbitrary output variables (AOVs) during rendering, such a shading position, a viewing direction, a light direction, and/or a visibility term. For surface-based digital assets 122, the neural module 202 is operable to determine a surface normal and for fiber-based digital assets 122, the neural module 202 further outputs a cross-section offset and a fiber direction. The cross-section offset represents a distance from an axis of the fiber that intersects with a ray such as depicted in FIG. 5 and further discussed below.

In some examples, the neural module 202 determines that the lighting source in a training image includes a directional light. The neural module 202 then smooths the directional light using regularization techniques by transforming the directional light into a finite cone (e.g., with a radius of 2°). In this way, the light source subtends a finite solid angle, which reduces artifacts for specular materials. Accordingly, the techniques described herein support generation of an expansive training dataset 210 that includes training data to represent a variety of view directions and lighting conditions of the digital asset 122.

The neural module 202 leverages the training dataset 210 to update the triplane representation 204 and/or adjust weights of the MLP 206. For instance, the neural module 202 predicts an outgoing radiance based on a training sample and uses the ground truth radiance with a loss function, e.g., an L2 error with log (x+1), to update the triplane representation 204 and weights of the MLP 206. In one example, between the triplane representation 204 and the MLP 206, the neural module 202 optimizes 6.4 million parameters. In this way, the neural module 202 configures the compressed representation 118 as a relightable neural asset, which is renderable under a variety of unseen illumination conditions and view directions.

Once generated, the compression module 116 includes a rendering module 212 that is operable to deploy the compressed representation 118 of the digital asset 122 into the digital scene (block 1006). For instance, the rendering module 212 inserts the compressed representation 118 into the digital scene at a location relative to one or more digital scene elements. In one or more examples, the location is defined based on a set of three-dimensional coordinates for the digital scene. The digital scene elements include but are not limited to digital light sources, additional digital objects, shadows, materials/textures, virtual cameras/points-of-view, backgrounds, visual effects, particle systems (e.g., smoke/fog simulations), etc. that impact lighting conditions.

The rendering module 212 then renders the digital asset 122 by applying one or more lighting effects 214 to the three-dimensional geometry (block 1008). The lighting effects 214, for instance, are based on the precomputed light transport and a location relative to the one or more digital scene elements. For instance, the rendering module 212 obtains scene data 216 such as a view direction and/or the location of the compressed representation 118 within the digital scene relative to the digital scene elements. In some examples, the scene data 216 denotes a type of digital light source included in the digital scene, e.g., point light, area light, directional light, distant light, etc. By applying the lighting effects 214 to the three-dimensional geometry of the digital asset 122 (as represented by the compressed representation 118) the rendering module 212 generates a relit asset 124.

In various implementations, the lighting effects 214 include a shading operation to determine a visual appearance of the relit asset 124 based on various features of the digital scene such as one or more digital scene elements. For example, a shading operation to relight the digital asset 122 includes application of color values to pixels that depict the digital asset 122 to produce a realistic appearance based on the scene data 216. The rendering module 212 is thus operable to determine color values to apply to points on the three-dimensional geometry of the digital asset 122 to impart realistic lighting effects 214.

The techniques described herein are implementable using a variety of rendering techniques, architecture, and/or hardware. Accordingly, in one example the rendering module 212 includes a rasterizer-based renderer such as a rasterizer 218 to generate the relit asset 124. In an additional or alternative example to render the relit asset 124, the rendering module 212 leverages a path tracer 220 to trace primary rays from a virtual camera that defines a view direction to intersection points with the compressed representation 118. In various examples, the rendering module 212 jitters a direction of one or more of the primary rays within a respective pixel. The rendering module 212 then computes a color value to apply to a pixels associated with the intersection points based on the precomputed light transport.

To do so, the rendering module 212 queries the triplane representation 204 at a coordinate that corresponds to an intersection point of a ray with the compressed representation 118 to generate an input vector 208. The input vector 208, for instance, includes information obtained from the triplane representation 204 about the digital asset 122 as well as information learned during training such that input of the input vector 208 to the MLP 206 yields a shading value, e.g., an RGB value. In one or more examples, the input vector 208 includes a feature vector 222 extracted from the planes of the triplane representation 204 as well as a property vector 224 that represents properties of the digital asset 122 at the intersection point.

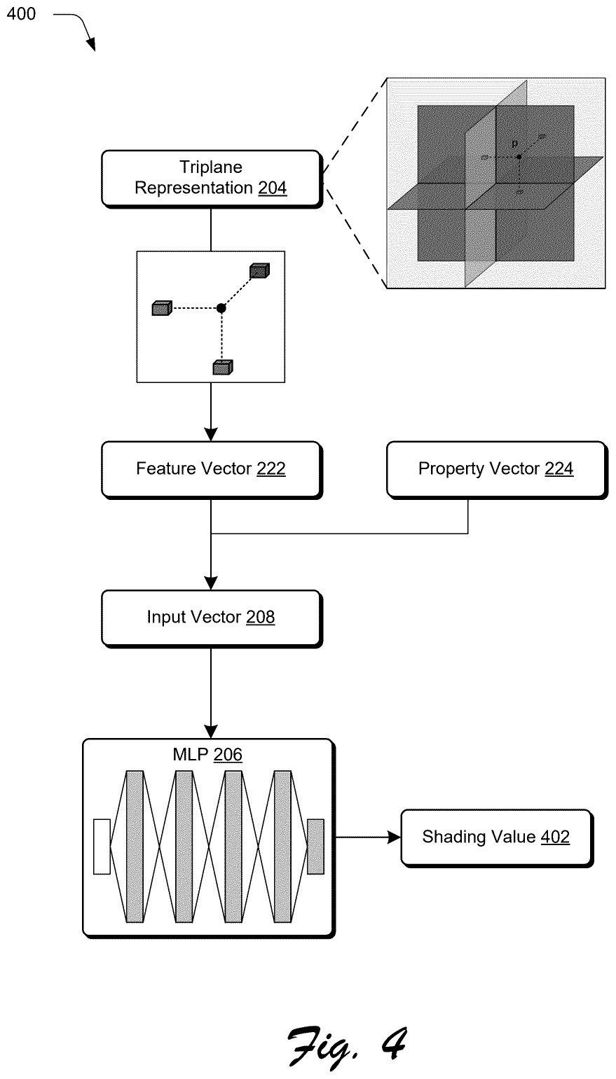

FIG. 4 depicts an example 400 to generate a shading value 402 to apply to a shading point of the digital asset 122. In this example, the rendering module 212 determines a shading point, e.g., an intersection point of a primary ray traced from the digital camera with the compressed representation 118. The rendering module 212 queries the triplane representation 204 at coordinates that correspond to the shading point to generate the feature vector 222.

Generally, the feature vector 222 is a multidimensional representation that includes information about the digital asset 122. The feature vector 222 further includes information (e.g., parameters and/or weights) learned during training. In some examples, the feature vector 222 includes a sum of features that are bilinearly interpolated from the orthogonally projected planes of the triplane representation 204. Consider that the shading position, denoted in the illustrated example as p, is represented as a three-dimensional vector {x, y, z} which is converted to three two dimensional vectors {x, y}, {y, z}, and {z, x}. The triplane representation 204, represented mathematically in this example as ζ, thus includes three two-dimensional tables for each vector, e.g., ζ_{xy}, ζ_{yz}, and ζ_{zx}. The rendering module 212 queries a vector (e.g., an eight-channel vector) from each dimension of the triplane representation 204 and sums the respective vectors to generate the feature vector 222.

The rendering module 212 is further operable to generate a property vector 224 that includes information about the digital asset 122 and/or the digital scene particular to the intersection point. In an example, the property vector 224 includes a view direction from the intersection point to a virtual camera that defines a view angle for the digital scene. Additionally or alternatively, the property vector 224 includes a light direction to a light source in the digital scene.

In some examples, the property vector 224 further includes a visibility term that represents self-occlusion properties of the digital asset 122. Inclusion of the visibility term improves self-shadowing of the compressed representation 118 which in turn increases the visual quality of the rendered digital asset, e.g., the relit asset 124. To calculate the visibility term, the rendering module 212 is configured to trace a ray, referred to herein as an occlusion ray, from the intersection point along the light direction, e.g., in a direction to a digital light source within the digital scene. The rendering module 212 generates the visibility term as a binarized value based on whether the occlusion ray intersects with the three-dimensional geometry. For instance, if the occlusion ray intersects the three-dimensional geometry, the rendering module 212 determines the intersection point is occluded by the digital asset 122 and assigns the visibility term as zero. If the occlusion ray does not interest the three-dimensional geometry, the rendering module 212 determines the intersection point is not occluded and assigns the visibility term as one. In this way, the techniques described herein increase realism of the relit asset 124 by accounting for self-occlusion to determine detailed shadowing effects.

In various examples, the property vector 224 further includes information based on the three-dimensional geometry of the digital asset 122. Consider FIG. 5 which depicts an example 500 of property vectors for a surface-based digital asset 122 and a fiber-based digital asset 122 in a first example 502 and a second example 504. As shown in the first example 502, the property vector 224 for a surface-based digital asset 122 includes a view direction ωₒ, a light direction ωᵢ, a visibility term, and a surface normal n. The surface normal represents a vector that is perpendicular to the surface of the digital asset 122 at the intersection point. Inclusion of the surface normal supports high fidelity rendering of surface-based assets.

The second example 504 depicts a property vector 224 for a fiber-based asset, e.g., a digital asset 122 with one or more fiber primitives. In this example, the intersection point is with one of the fiber primitives, e.g., a strand of hair modelled as an elongated cylinder. The property vector 224 includes a view direction ωₒ, a light direction ωᵢ, and a visibility term similar to the surface-based asset. The property vector 224 in this example further includes a tangent term/that represents a direction of the fiber at the intersection point as well as a cross-section offset, denoted h. As illustrated, the cross-section offset (i.e., a fiber axis-offset) represents a distance from the center of the fiber that the ray intersects with the fiber. Inclusion of asset-specific properties, such as the tangent term and cross-section offset, further increases realism when relighting the digital asset 122.

Continuing with the example in FIG. 4, the rendering module 212 concatenates the feature vector 222 and the property vector 224 to generate the input vector 208. The rendering module 212 then passes the input vector 208 to the trained MLP 206, which evaluates the input vector 208 to generate a radiance value, e.g., an RGB value. The rendering module 212 repeats this process for each intersection point of primary rays with the compressed representation 118. In this way, the rendering module 212 determines a color value to apply to each visible pixel to generate the relit asset 124. By determining a radiance value based on the first intersection of a ray with the digital asset 122, the techniques described herein overcome the limitations of computationally expensive conventional techniques that calculate multiple scattering paths for each ray. Accordingly, the techniques described herein support high-fidelity and realistic renderings in a computationally efficient manner and are further integrable into a variety of existing rendering pipelines.

### Example Implementations

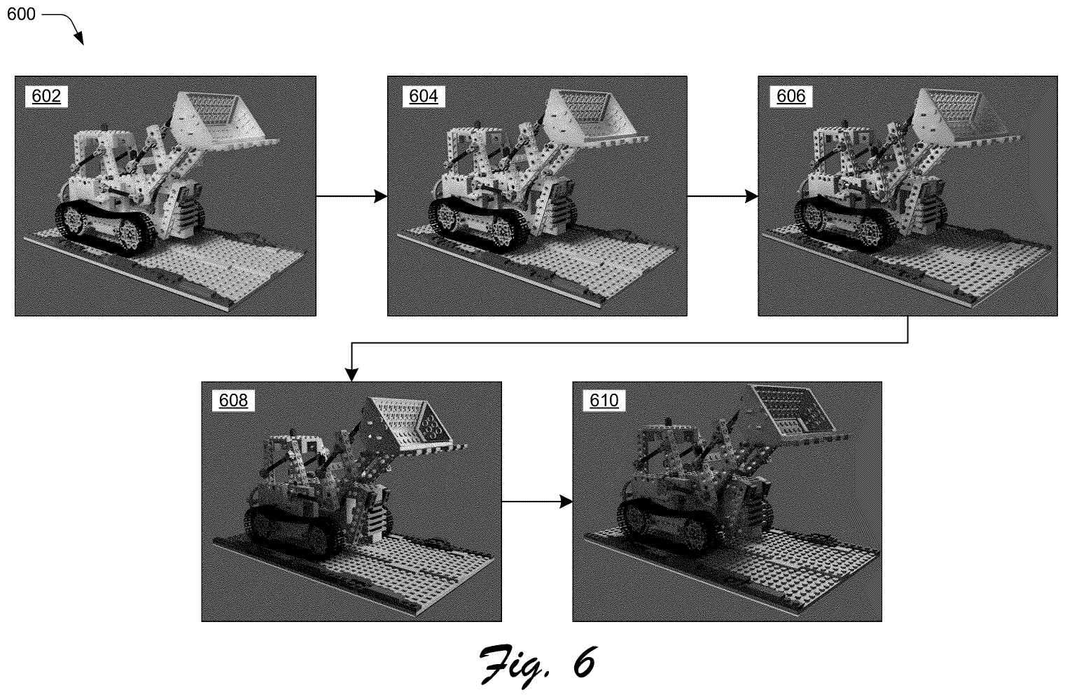

FIG. 6 depicts an example 600 of generation of relit digital assets based on a compressed representation 118 with a changed condition of a digital light source in stages 602, 604, 606, 608, and 610. In various implementations, a condition of digital light source, (e.g., an intensity of the digital light source, a spatial location of the digital light source within the digital scene, a type of illumination, etc.) is changed. Accordingly, the rendering module 212 is operable to update the one or more lighting effects based on the changed condition in real time. In the illustrated example, for instance, a compressed representation 118 is rendered to depict an interlocking building block model of a track loader in a digital scene with a moving directional light source while a view direction of the track loader remains consistent. As depicted, as the light source moves around the track loader from first stage 602 to the final stage 610 the appearance of the track loader is updated in accordance with the rendering techniques described herein.

Conventional approaches to render such digital assets include computation of a complex light transport including multiple scattering interactions at each stage, which involves significant processing resources and time to render. However, by precomputing the light transport the techniques described herein enable visualization of dynamic interactions within a digital scene with reduced rendering times. Thus, the techniques described herein are usable in a variety of real-time applications, as well as implementable on low-resource and/or standard resource devices, which is not possible using conventional techniques.

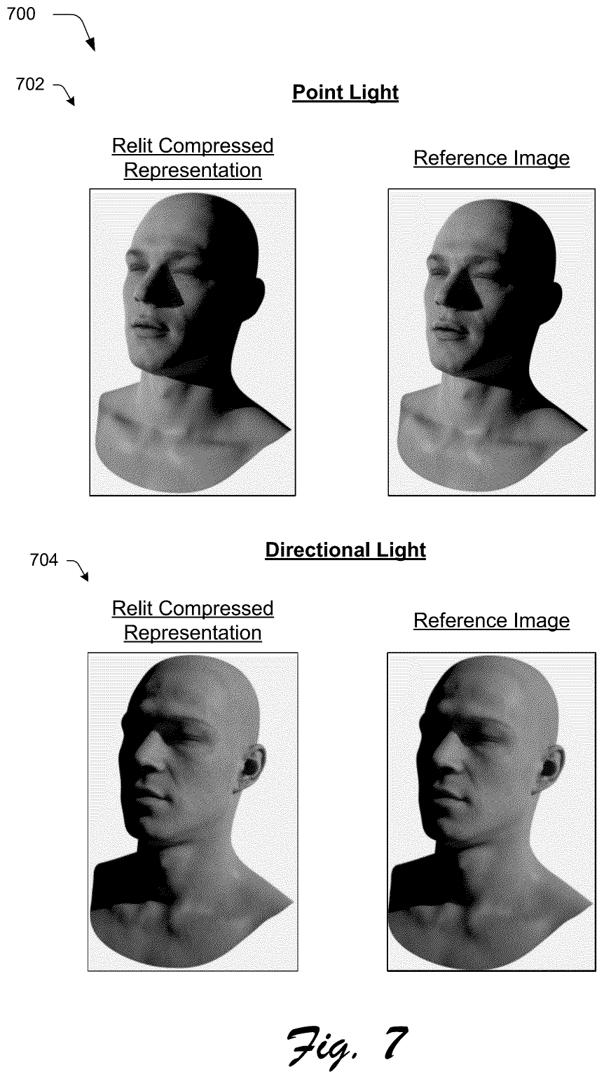

FIG. 7 depicts an example 700 of generation of relit assets 124 based on a compressed representation 118 under different lighting conditions in a first example 702 and a second example 704. As shown in the first example 702, a compressed representation 118 is based on a model of a human head and rendered under a point light source in accordance with the techniques described herein. The first example 702 further depicts a reference image, e.g., a ground truth image of the head model generated using path tracing techniques, which is photorealistic however is computationally expensive to generate.

The second example 704 depicts the compressed representation 118 of the head model rendered under a directional light source. Similar to the first example 702, a reference image of the head model generated using path tracing techniques is depicted. As illustrated, the renderings in both the first example 702 and the second example 704 based on the compressed representation 118 of the head model include accurate lighting and color and have a visual quality comparable to the ground truth images. Further, the renderings based on the compressed representation 118 take into consideration self-occlusion properties through incorporation of the visibility term, and accordingly the renderings accurately depict high-fidelity shadowing and subtle visual effects due to transparency properties of the skin. This level of detail is not possible using conventional methods that attempt to simplify the rendering process, e.g., via a simplified shading model.

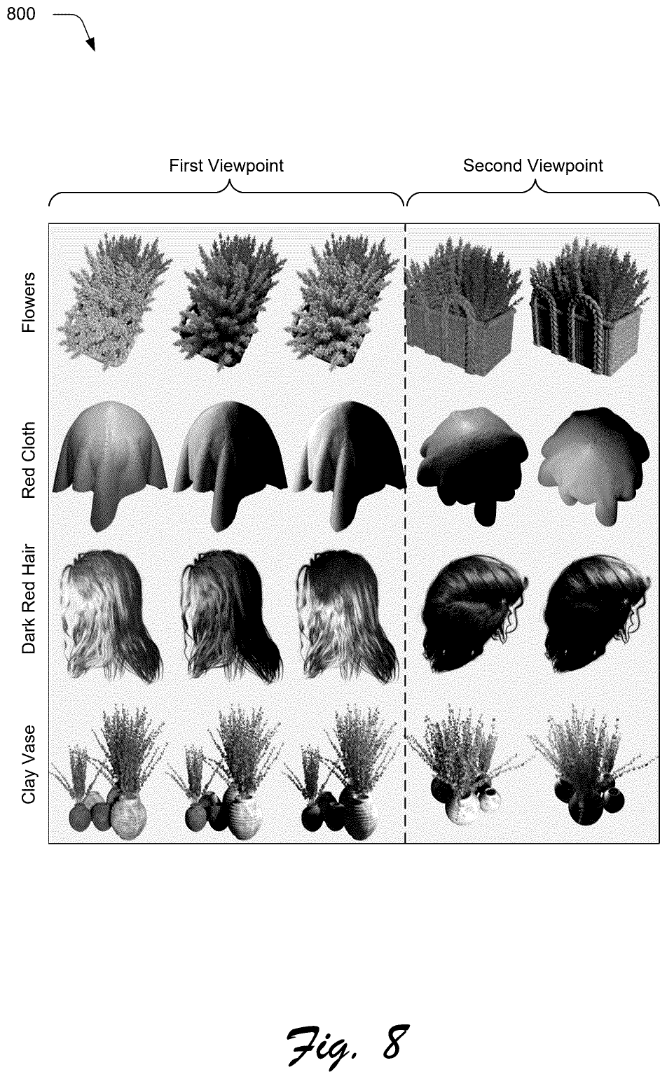

FIG. 8 depicts an example 800 of rendering a variety of digital assets 122 based on compressed representations 118 with various lighting conditions and view directions. As depicted in the illustrated example, the digital assets 122 represents various digital objects with complex geometries, e.g., a wicker basket with different types of flowers, a red cloth, a dark red hair assembly, and clay vases with different plants. Because the compressed representation 118 includes the triplane representation 204, the techniques described herein are able to represent a variety of digital assets 122 with unique geometries and material properties.

The digital assets 122 are rendered in accordance with the techniques described herein from a first viewpoint and a second viewpoint. For each viewpoint, the lighting conditions of the digital scene are changed. For instance, the flowers are rendered from the first viewpoint with three different lighting conditions and rendered from a second viewpoint under two different lighting conditions. As illustrated, the renderings for each asset type are photorealistic across each of the lighting types and view directions. This example further demonstrates the versatility of the techniques described herein to represent a variety of digital assets 122 with differing geometries and material properties in dynamic digital environments while conserving computational resources.

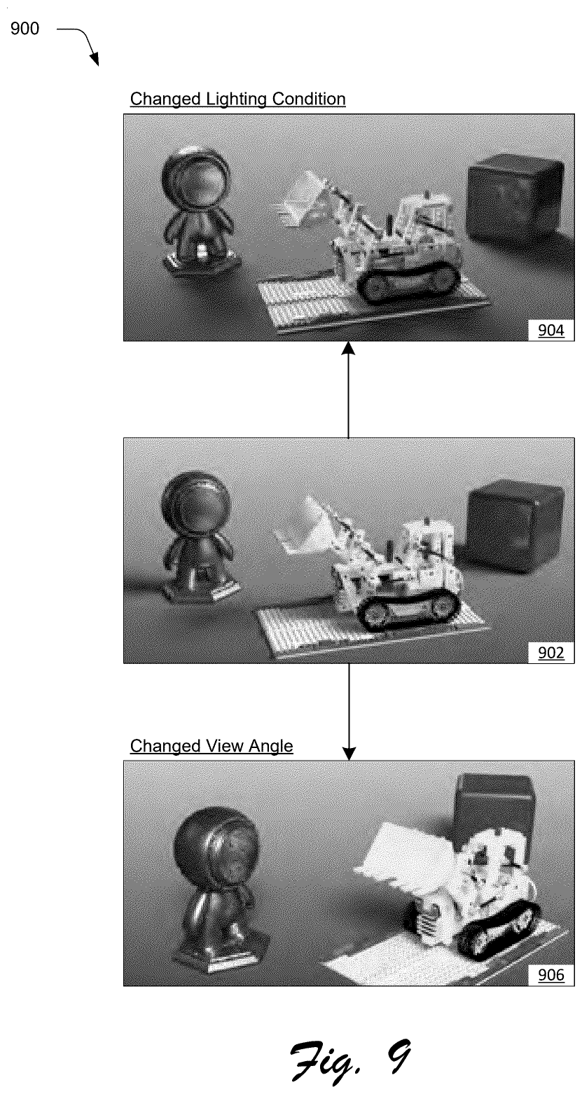

FIG. 9 depicts an example 900 of rendering multiple digital assets 122 based on compressed representations 118 within a digital scene in a first image 902, a second image 904, and a third image 906. The first image 902 depicts a digital scene that includes a representation of a track loader, a silver figurine, and a brown block. The second image 904 depicts a changed light condition from the first image 902 and the third image 906 depicts a changed view angle from the first image 902.

As described above, the rendering module 212 is operable to consider a visual effect of one or more digital scene elements, e.g., one or more additional digital assets included in the digital scene. Consider that in this example the track loader and the silver figurine are rendered based on compressed representations 118. The compression module 116 is operable to trace a ray, e.g., a secondary ray, from a first digital asset to a second digital asset. For example, the compression module 116 traces a secondary ray from the track loader to the silver figurine and leverages the compressed representation 118 of the silver figurine to determine appropriate lighting effects to apply based on the visual influence of the track loader without computation of complex scattering interactions.

Thus, the techniques described herein are further usable to support computationally efficient relighting of digital scenes with multiple digital assets. By way of example, as illustrated in the first image 902, the silver figurine has lighting effects 214 applied that incorporate lighting contributions of the yellow track loader and the brown block. For instance, the silver figurine includes a reflection of the track loader and further includes shadowing effects caused by the track loader. The brown block also displays a reflection of the track loader.

These techniques are extensible to update the lighting effects 214 based on changed conditions of the digital scene in real time. As illustrated in the second image 904, as the lighting condition is changed, e.g., a digital light source within the digital scene moves behind the three digital assets 122, the lighting effects 214 change accordingly in real time. For instance, the shadow of the silver figurine impacts a visual appearance of the yellow track loader. Further, the reflection of the track loader on the silver figurine and on the brown block is more pronounced than in the first image 902, as the light source is now located behind the objects.

Further, as depicted in the third image 906, as the view angle changes the lighting effects 214 are updated in real time. For instance, the track loader appears brighter, and the reflection of the track loader on the silver figurine has changed. Further, shadowing and reflective properties of the brown block caused by the track loader are updated based on the changed view angle. In this way, the techniques described herein support high fidelity lighting operations that consider inter-asset illumination and global light transport with reduced computation of scattering interactions. Thus, these techniques conserve computational resources relative to conventional techniques.

### Example System and Device

FIG. 11 illustrates an example system generally at 1100 that includes an example computing device 1102 that is representative of one or more computing systems and/or devices that implement the various techniques described herein. This is illustrated through inclusion of the compression module 116. The computing device 1102 is configurable, for example, as a server of a service provider, a device associated with a client (e.g., a client device), an on-chip system, and/or any other suitable computing device or computing system.

The example computing device 1102 as illustrated includes a processing system 1104, one or more computer-readable media 1106, and one or more I/O interface 1108 that are communicatively coupled, one to another. Although not shown, the computing device 1102 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware element 1110 that is configurable as processors, functional blocks, and so forth. This includes implementation in hardware as an application specific integrated circuit or other logic device formed using one or more semiconductors. The hardware elements 1110 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1106 is illustrated as including memory/storage 1112. The memory/storage 1112 represents memory/storage capacity associated with one or more computer-readable media. The memory/storage 1112 includes volatile media (such as random access memory (RAM)) and/or nonvolatile media (such as read only memory (ROM), Flash memory, optical disks, magnetic disks, and so forth). The memory/storage 1112 includes fixed media (e.g., RAM, ROM, a fixed hard drive, and so on) as well as removable media (e.g., Flash memory, a removable hard drive, an optical disc, and so forth). The computer-readable media 1106 is configurable in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1102. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1102, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employed to implement various techniques described herein. Accordingly, software, hardware, or executable modules are implemented as one or more instructions and/or logic embodied on some form of computer-readable storage media and/or by one or more hardware elements 1110. The computing device 1102 is configured to implement particular instructions and/or functions corresponding to the software and/or hardware modules. Accordingly, implementation of a module that is executable by the computing device 1102 as software is achieved at least partially in hardware, e.g., through use of computer-readable storage media and/or hardware elements 1110 of the processing system 1104. The instructions and/or functions are executable/operable by one or more articles of manufacture (for example, one or more computing devices 1102 and/or processing systems 1104) to implement techniques, modules, and examples described herein.

The techniques described herein are supported by various configurations of the computing device 1102 and are not limited to the specific examples of the techniques described herein. This functionality is also implementable all or in part through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 include applications and/or data that can be utilized while computer processing is executed on servers that are remote from the computing device 1102. Resources 1118 can also include services provided over the Internet and/or through a subscriber network, such as a cellular or Wi-Fi network.

The platform 1116 abstracts resources and functions to connect the computing device 1102 with other computing devices. The platform 1116 also serves to abstract scaling of resources to provide a corresponding level of scale to encountered demand for the resources 1118 that are implemented via the platform 1116. Accordingly, in an interconnected device embodiment, implementation of functionality described herein is distributable throughout the system 1100. For example, the functionality is implementable in part on the computing device 1102 as well as via the platform 1116 that abstracts the functionality of the cloud 1114.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a digital asset defined by a three-dimensional geometry to be included in a digital scene, the digital scene including at least one digital scene element;
generating, by the processing device, a compressed representation of the digital asset, the compressed representation including:
a triplane representation of the three-dimensional geometry; and
a precomputed light transport based on the three-dimensional geometry;
deploying, by the processing device, the compressed representation into the digital scene at a location relative to the at least one digital scene element; and
rendering, by the processing device, the digital asset by applying one or more lighting effects to the three-dimensional geometry based on:
the precomputed light transport; and
the location relative to the at least one digital scene element.

2. The method as described in claim 1, wherein the triplane representation includes feature grids that correspond to dimensions of the three-dimensional geometry to represent the digital asset.

3. The method as described in claim 1, wherein the one or more lighting effects are based in part on a visibility term included in the compressed representation that represents self-occlusion properties of the digital asset.

4. The method as described in claim 1, wherein rendering the digital asset includes determining an intersection point of a ray traced from a virtual camera that defines a view direction with the compressed representation and computing a color value to apply to the compressed representation at the intersection point based on the precomputed light transport.

5. The method as described in claim 4, wherein the compressed representation further includes a multilayer perceptron, and rendering the digital asset includes:
generating an input vector that corresponds to the intersection point based on the triplane representation; and
evaluating the input vector using the multilayer perceptron to determine the color value.

6. The method as described in claim 5, wherein the input vector is a concatenation of a feature vector extracted from the triplane representation and a property vector that defines one or more properties of the digital asset at the intersection point.

7. The method as described in claim 6, wherein the digital asset is a fiber-based digital asset that includes one or more fiber primitives and the property vector includes data to represent a view direction, a light direction, a tangent, a cross-section offset, and a visibility term particular to the intersection point.

8. The method as described in claim 6, wherein the digital asset is a surface-based digital asset and the property vector includes data to represent a view direction, a light direction, a normal, and a visibility term particular to the intersection point.

9. The method as described in claim 1, wherein the at least one digital scene element includes one or more of a light source or an additional digital asset.

10. A system comprising:
a memory component; and
a processing device coupled to the memory component, the processing device to perform operations comprising:
receiving a digital asset defined by a three-dimensional geometry to be included in a digital scene, the digital scene including at least one digital scene element;
generating a compressed representation of the digital asset, the compressed representation including:
a triplane representation of the three-dimensional geometry; and
a precomputed light transport based on the three-dimensional geometry;
inserting the compressed representation into the digital scene at a location relative to the at least one digital scene element; and
rendering the digital asset by applying one or more lighting effects to the three-dimensional geometry based on:
the precomputed light transport; and
the location relative to the at least one digital scene element.

11. The system as described in claim 10, wherein the triplane representation includes feature grids that correspond to dimensions of the three-dimensional geometry to represent the digital asset.

12. The system as described in claim 10, wherein the one or more lighting effects are based in part on a visibility term included in the compressed representation that indicates whether portions of the digital asset are occluded by other portions of the digital asset.

13. The system as described in claim 12, the operations further comprising computing the visibility term by tracing an occlusion ray from a first point on the compressed representation to a light source included in the digital scene and determining whether the occlusion ray intersects a second point of the compressed representation.

14. The system as described in claim 10, the operations further comprising generating a training dataset that includes training images depicting the digital asset viewed from a plurality of different locations within the digital scene.

15. The system as described in claim 14, wherein generating the compressed representation includes utilizing the training dataset to adjust weights of a multi-layer perceptron of the compressed representation and update the triplane representation of the compressed representation.

16. The system as described in claim 14, wherein the training dataset includes training samples for each pixel of the training images, the training samples including a visibility term.

17. The system as described in claim 10, wherein the at least one digital scene element includes one or more of a light source or an additional digital asset.

18. A non-transitory computer-readable medium storing executable instructions, which when executed by a processing device, cause the processing device to perform operations comprising:
receiving a digital asset defined by a three-dimensional geometry to be included in a digital scene, the digital scene including at least one additional digital asset;
generating a triplane representation of the three-dimensional geometry to be included as part of a compressed representation that includes a precomputed light transport for the digital asset;
inserting the compressed representation of the digital asset into a location relative to the at least one additional digital asset within the digital scene; and
rendering the digital asset by applying one or more lighting effects to the three-dimensional geometry based on:
the precomputed light transport; and
the location relative to the at least one additional digital asset.

19. The non-transitory computer-readable medium as described in claim 18, wherein the one or more lighting effects are based in part on a visibility term included in the compressed representation that represents self-occlusion properties of the digital asset.

20. The non-transitory computer-readable medium as described in claim 18, wherein the rendering the digital asset includes using one or more of a path tracer or a rasterizer-based renderer.
